(19) United States
(12) Patent Application Publication
(10) Pub. No.: US 2003/0213459 A1
(43) Pub. Date: Nov. 20, 2003

(54) Injection needle with flexible needle tip

(76) Inventors: Thomas Hofmann, Regensburg (DE); Alwin Perras, Breitenbrunn (DE); Hakan Yalcin, Neu-Ulm (DE)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/428,359

(22) Filed: May 2, 2003

Related U.S. Application Data
(63) Continuation of application No. PCT/DE01/04102, filed on Oct. 30, 2001.

(30) Foreign Application Priority Data
Nov. 2, 2000 (DE) 10054183.6

(51) Int. Cl. F02B 53/10

(52) U.S. Cl. 123/208

(57) ABSTRACT

An injection needle comprising a needle tip, elastically connected to a needle shaft by means of a connector piece. A damping of the force with which the needle tip hits the corresponding sealing seat is possible by means of the elastic connection. The load on the sealing seat is thus reduced.

### CROSS-REFERENCE TO RELATED APPLICATION

This application is a continuation of co-pending International Application No. PCT/DE01/04102 filed Oct. 30, 2001 which designates the United States, and claims priority to German application number DE10054183.6 filed Nov. 2, 2000.

### TECHNICAL FIELD OF THE INVENTION

The invention relates to an injection needle and an injection valve with such an injection needle.

### BACKGROUND OF THE INVENTION

Injection needles have an enormous variety of forms, in particular in the region of the needle tip, with a resulting impact on the flow of fuel. A sealing surface is also configured at the needle tip, which is assigned to a sealing seat of a nozzle body. The sealing seat is subject to high levels of dynamic and static loading when the injection valve opens and closes. Small differences in the adjustment of the injection needle in the injection valve result in a higher level of wear at the sealing seat. Wear causes an increase in the lift of the injection needle and/or leakage at the sealing seat. It is already known how to configure expensive geometries at the sealing seat or at the injection needle to keep sealing seat wear within limits.

### SUMMARY OF THE INVENTION

It is therefore the object of the invention to provide a simply structured injection needle with which the sealing seat is subject to a lower level of wear.

The object of the invention is achieved by means of an injection needle for an injection valve, said needle comprising the following features: a needle body comprising a needle shaft and a needle tip, and a sealing surface configured on the needle tip, said surface being configured to rest on a sealing seat of the nozzle body, wherein the needle tip is connected via an impetus-damping element to the needle shaft.

A significant advantage of the invention is that the needle tips are connected to the needle shaft by means of a flexible element. The flexible element damps the impetus with which the injection needle hits a sealing seat with the needle tip, so the sealing seat is subject to a lower level of loading.

A preferred embodiment of the flexible element involves configuring a connector piece disposed with central symmetry between the needle shaft and the needle tip. The needle tip, connector piece and needle shaft are configured as a single part. This results in a particularly simple embodiment of the invention.

The connector piece is preferably configured in such a way that a ring-shaped circumferential groove is incorporated into the injection needle, defining the connector piece.

A preferred embodiment of the invention involves configuring the connector piece with a diameter of 0.5 to 1.5 mm.

Good flexible properties of the needle tip are achieved if the groove is at a distance in the range of 0 to 1 mm from a sealing edge of the needle tip.

In a preferred embodiment, the groove has a U-shaped cross section. A U-shaped groove is simple to incorporate, so the injection needle can be manufactured at low cost.

### BRIEF DESCRIPTION OF THE DRAWINGS

The invention is described in more detail below using the figures:

FIG. 1 a diagrammatic structure of an injection valve; and

FIG. 2 a needle tip with a needle shaft.

### DETAILED DESCRIPTION OF THE PREFERRED EMBODIMENTS

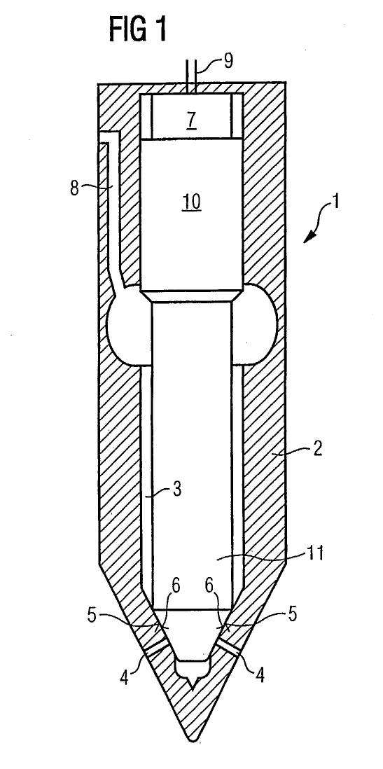

FIG. 1 shows an injection valve 1, which has a nozzle body 2. An injection needle 10 is guided in a movable manner in the nozzle body 2. The injection needle 10 has a needle tip 11 with a sealing surface 6. When the injection valve 1 is in the closed position, the sealing surface 6 lies with one sealing edge 22 on a sealing seat 5, which is configured above injection holes 4 on the inner wall of the nozzle body 2. An injection chamber 3 is configured between the injection needle 10 and the nozzle body 2, said chamber being connected to an intake hole 8. The injection chamber 3 is supplied with fuel via the intake hole 8. In a preferred embodiment, the intake hole 8 is connected to a fuel store, which supplies fuel at a predetermined pressure.

In the injection valve 1, an actuator 7 is disposed above the injection needle 10 with electrical connections 9. The actuator 7 is actively connected to the injection needle 10 and determines the position of the injection needle 10 on the basis of activation via the connections 9. If injection is to take place, the actuator 7 is activated accordingly and the injection needle 10 is lifted off the sealing seat 5 by the actuator 7. This results in a hydraulic connection between the injection chamber 3 and the injection holes 4. Fuel is supplied via the injection holes 4 as a result.

If injection is to be terminated, activation of the actuator 7 is interrupted and the actuator 7 moves the injection needle back with the sealing surface 6 onto the sealing seat 5, so that the hydraulic connection between the injection chamber 3 and the injection holes 4 is broken.

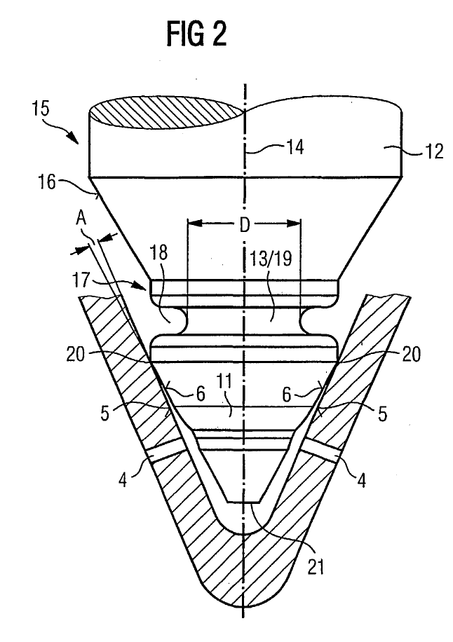

FIG. 2 shows a partial section of the front area of the injection needle 10 and the nozzle body 2. The injection needle 10 is subdivided into a needle shaft 12 and a needle tip 11, with the needle tip 11 being connected by means of a connector piece 13 to the needle shaft 12. The needle tip 11 comprises a tapered sealing surface 6, which is configured with rotational symmetry in respect of an axis of symmetry 14. The sealing surface 6 is assigned a tapered sealing seat 5, which is also configured with rotational symmetry in respect of the axis of symmetry 14 on the inner wall of the nozzle body 2. A differential angle A is configured between the sealing surface 6 and the sealing seat 5 so that a reliable seal is ensured between the sealing seat 5 and the sealing surface 6. In the closed position, the sealing surface 6 lies above the injection holes 4 with the sealing edge 22 on the sealing seat 5 in a circumferential ring surface.

The needle shaft 12 changes from a first cylindrical section 15 to a second tapered section 16. A third section 17 is connected to the second section 16 and is also configured as cylindrical but has a smaller cross-section than the first section 15. The third section 17 in turn tapers over a circumferential ring-shaped groove 18 in a fourth section 19, which represents the connector piece 13. The cross-section then expands starting from the fourth section 19 in a fifth section 20. The fifth section 20 represents the upper part of the needle tip 11. The needle tip 11 tapers in the shape of the sealing surface 6 up to an end surface 21, which completes the needle tip 11.

The fifth section 20 and the third section 17 preferably have the same cross-section. The groove 18 preferably has a U-shaped cross-section. Other shapes of groove 18 are however possible.

The connector piece 13 is preferably disposed with central symmetry in respect of the axis of symmetry 14 and preferably has a diameter D of 0.5 to 1.8 mm. A preferred size for the diameter of the connector piece 13 is in the range from 1.1 to 1.3 mm.

The width B of the groove 18 viewed parallel to the axis of symmetry 14 preferably has a value of 0.1 to 1 mm. Particularly good properties have been achieved with a groove width of 0.25 to 0.35 mm.

The groove 18 comprises a lower edge 23, at which the needle tip 11 tapers to the connector piece 13. The distance between the sealing edge 22 and the lower edge 23 is of particular significance, as the distance essentially determines the flexible properties of the connection of the needle tip to the injection needle and therefore the damping properties of the injection needle. Good damping properties are achieved with a distance Z of the lower edge 23 from the sealing edge 22, which is in the range of 0.1 to 1 mm.

The lower edge 23 preferably runs perpendicular to the longitudinal axis of the injection needle after a curve. An important function of the groove 18 is to achieve a reduction of the cross-section of the connector piece 13.

Tests have shown that a configuration of the connector piece 13 with a short distance to the sealing edge 22 facilitates particularly damping properties. However it is advantageous for reasons of manufacturing accuracy and possible wear to maintain a specified distance from the sealing edge 22.

The damping action of the connector piece 13 means that the maximum yield stress, exercised by the needle tip 11 on the nozzle body 2, can be reduced by up to 50%.

Preferred values for a combination of the diameter D and the distance Z are 1-1.3 mm for the diameter D and 0.1 to 1 mm for the distance Z.

The injection needle 10 in FIG. 2 is configured as a single part comprising the needle shaft 12, the connector piece 13 and the needle tip 11. For example the injection needle 10 is manufactured from working steel S 652 or the material 100 chrome 6.

The invention is however not limited to the single part configuration form but the needle shaft 12, the connector piece 13 and the needle tip 11 can also be made from different materials, with the connector piece 13 being connected to the needle shaft 12 and the needle tip 11 by means of appropriate connecting surfaces or connecting means. For example the connector piece 13 can be screwed into the needle shaft 12 and the needle tip 11 or be welded to the needle shaft 12 and the needle tip 11.

In this embodiment the connector piece 13 is preferably made from a material which has more damping properties than the material of the needle shaft 12 and/or the material of the needle tip 11.

FIG. 3 shows a further embodiment of the injection needle, in which the lower edge 23 is taken up to a diameter D of the connector piece 13. The lower edge 23 changes to a radius of curvature R, which is in the range of 0.15 to 0.4 mm. A truncated cone-shaped transition surface 24 connects tangentially to the radius of curvature forming an angle of 40° to 75° with the central axis of the injection needle. The diameter of the injection needle increases again constantly up to the diameter of the needle shaft 12 starting from the radius of curvature R.

Good damping properties are achieved with this embodiment too. Tests show that the size of the span of the connector piece 13 parallel to the longitudinal axis of the injection needle has little impact on the damping properties of the connection with the needle tip 11. The distance Z and diameter D of the constriction of the injection needle between the needle tip and the needle shaft are significant.

The values for the distance Z and the diameter D are adapted by a person skilled in the art in conjunction with the flexible properties of the material from which the injection needle is manufactured.

What is claimed is:

1. Injection needle for an injection valve with a needle body comprising a needle shaft and a needle tip, and a sealing surface configured on the needle tip, said surface being configured to rest on a sealing seat of the nozzle body, wherein the needle tip is connected via an impetus-damping element to the needle shaft.

2. An injection needle according to claim 1, wherein the needle tip passes over a groove into a connector piece disposed with central symmetry, said connector piece having a diameter and connected to the needle shaft, the diameter of the connector piece configured such that the needle tip hits the sealing seat with less force.

3. An injection needle according to claim 2, wherein the connector piece includes ring-shaped groove.

4. An injection needle according to claim 2, wherein the connector piece has a diameter of about 0.5 to about 1.8 mm.

5. An injection needle according to claim 3, wherein the connector piece has a diameter of about 0.5 to about 1.8 mm.

6. An injection needle according to claim 2, wherein the groove is at a distance of about 0.1 to about 1 mm from a sealing edge of the needle tip.

7. An injection needle according to claim 3, wherein the groove is at a distance of about 0.1 to about 1 mm from a sealing edge of the needle tip.

8. An injection needle according to claim 4, wherein the groove is at a distance of about 0.1 to about 1 mm from a sealing edge of the needle tip.

9. An injection valve including an injection needle according to claim 1.

10. An injection needle for an injection valve, said needle comprising:
a needle body comprising a needle shaft, a needle tip, and a sealing seat, said needle tip having a sealing surface, said surface being configured to rest on the seat of the body, and said tip being flexibly connected to the shaft.

11. An injection needle according to claim 10, wherein the tip passes over a groove into a connector piece, said connector piece having a diameter and connected to the needle shaft, said diameter of the connector piece being configured whereby contact between the tip and the seat is dampened.

12. An injection needle according to claim 11, wherein the connector piece includes a ring-shaped groove.

13. An injection needle according to claim 11, wherein the connector piece has a diameter of about 0.5 to about 1.8 mm.

14. An injection needle according to claim 12, wherein the connector piece has a diameter of about 0.5 to about 1.8 mm.

15. An injection needle according to claim 12, wherein the groove is at a distance of about 0.1 to about 1 mm from a sealing edge of the tip.

16. An injection needle according to claim 13, wherein the groove is at a distance of about 0.1 to about 1 mm from a sealing edge of the tip.

17. An injection needle according to claim 14, wherein the groove is at a distance of about 0.1 to about 1 mm from a sealing edge of the tip.

18. An injection valve including an injection needle according to claim 10.

19. An injection needle for an injection valve, said needle comprising:
a needle body having a needle shaft, a needle tip, and a sealing seat, said needle tip having a sealing surface configured to rest on the seat of the body, said sealing surface tapered and configured with rotational symmetry with respect to an axis of symmetry of the injection needle, said sealing seat tapered and configured with rotational symmetry with respect to an axis of symmetry of the injection needle, a differential angle being configured between the sealing surface and the sealing seat, said needle tip configured as a body with rotational symmetry and connected via an impetus-damping element to the shaft, said impetus-damping element configured in the form of a groove, wherein the respective sections of the needle shaft and the needle tip that are directly adjacent to the groove have the same cross-section.

20. An injection needle according to claim 19, wherein the impetus-dampening element has a diameter of about 0.5 to about 1.8 mm.

21. An injection needle according to claim 19, wherein the groove is about 0.1 to about 1 mm from a sealing edge of the tip.

22. An injection needle according to claim 19, wherein the impetus-dampening element has a diameter of about 1.1 to about 1.3 mm.
